(19) United States
(12) Patent Application Publication
(10) Pub. No.: US 2013/0334811 A1
(43) Pub. Date: Dec. 19, 2013

(54) Apparatus and Method for Connecting between a Fluid Supply and a Service Pipe in a Building

(71) Applicant: Grant Gilbert, Houston, TX (US)

(72) Inventor: Grant Gilbert, Houston, TX (US)

(21) Appl. No.: 13/909,070

(22) Filed: Jun. 4, 2013

Related U.S. Application Data
(60) Provisional application No. 61/654,590, filed on Jun. 1, 2012.

(51) Int. Cl. F16L 25/10

(52) U.S. Cl. CPC F16L 25/10
USPC 285/31

(57) ABSTRACT

A tubular coupling member is configured to couple a fluid delivery pipe located external to a building with a service pipe located inside the building. The tubular coupling member includes a longitudinal axis and a pipe extending along the longitudinal axis. The pipe has a first end with a straight connector portion and a second end configured to couple to the service pipe. The straight connector portion includes an outer surface and a terminating taper. The outer surface has a substantially uniform outside diameter, and the taper extends radially inward from the outer surface toward the longitudinal axis.

### CROSS-REFERENCE TO RELATED APPLICATIONS

This application claims priority to provisional patent application No. 61/654,590 filed Jun. 1, 2012 and entitled “Apparatus and Method for Connecting to a Fluid Supply by Means of a Building Riser.”

### STATEMENT REGARDING FEDERALLY SPONSORED RESEARCH OR DEVELOPMENT

Not applicable.

### BACKGROUND

Buildings require pipe coupling assemblies to connect portions of the piping inside a building to a water supply system outside the building. For example, a pipe coupling assembly is used to connect a buried, i.e. subterranean, water supply line to water service and distribution lines within a building. The pipe coupling assembly may be used to supply potable water, for example. A common pipe coupling assembly includes a bell-shaped expanded coupler at its entry end, which is similar to the bell-shaped expanded coupler located at the end of a typical supply pipe. To couple the pipe coupling assembly to the water supply system, the final piece of supply pipe is cut to a size that nearly reaches the building site. A separate piece of straight pipe is cut to an appropriate length, and inserted into the bell bell-shaped couplers of both the final piece of supply pipe and the pipe coupling assembly, extending therebetween. The pipe coupling assembly is connected to a distribution line within a building. Thus, the connection between the final piece of supply pipe and the pipe coupling assembly is indirect and two pieces of material must be supplied and cut at the job site in order to couple the water supply system to the pipe coupling assembly. Alternate apparatus and methods for connecting the piping inside a building to a water supply system outside the building could offer economic advantages during construction or modification of a building.

### BRIEF DESCRIPTION OF THE DRAWINGS

For a detailed description of the disclosed embodiments of the invention, reference will now be made to the accompanying drawings in which:

FIG. 1 is an elevation view in partial cross-section of a building system incorporating a tubular coupling member in accordance with principles described herein;

FIG. 2 is a perspective view of the tubular coupling member in the building system of FIG. 1;

FIG. 3 is a side view of the straight connector used in the tubular coupling member of FIG. 2;

FIG. 4 is a schematic diagram of a method for transitioning a subterranean fluid supply system into a building zone in accordance with principles described herein;

FIG. 5 is a schematic diagram showing a continuation of the method FIG. 4 in accordance with principles described herein;

FIG. 6 is a tubular coupling member compatible with the building system of FIG. 1;

FIG. 7 is a tubular coupling member compatible with the building system of FIG. 1;

FIG. 8 is an end connector compatible with the tubular coupling members of FIG. 2, FIG. 6, and FIG. 7; and

FIG. 9 is an end connector compatible with the tubular coupling members of FIG. 2, FIG. 6, and FIG. 7.

### DETAILED DESCRIPTION OF THE DISCLOSED EMBODIMENTS

The embodiments described herein comprise a combination of features and advantages intended to address various shortcomings associated with certain prior devices, systems, and methods. The various characteristics of the embodiments, as well as other features, will be readily apparent to those skilled in the art upon reading the following detailed description, and by referring to the accompanying drawings.

The following description is exemplary of embodiments of the invention. These embodiments are not to be interpreted or otherwise used as limiting the scope of the disclosure, including the claims. One skilled in the art will understand that the following description has broad application, and the discussion of any embodiment is meant only to be exemplary of that embodiment, and is not intended to suggest in any way that the scope of the disclosure, including the claims, is limited to that embodiment.

The drawing figures are not necessarily to scale. Certain features and components disclosed herein may be shown exaggerated in scale or in somewhat schematic form, and some details of conventional elements may not be shown in the interest of clarity and conciseness. In some of the figures, in order to improve clarity and conciseness of the figure, one or more components or aspects of a component may be not depicted or may not have reference numerals identifying the features or components that are identified elsewhere. In addition, like or identical reference numerals may be used to identify common or similar elements.

The terms “including” and “comprising” are used herein, including in the claims, in an open-ended fashion, and thus should be interpreted to mean “including, but not limited to . . . .” Also, the term “couple” or “couples” is intended to mean either an indirect or direct connection. Thus, if a first component couples or is coupled to a second component, the connection between the components may be through a direct engagement of the two components, or through an indirect connection that is accomplished via other intermediate components, devices and/or connections.

In addition, when used herein (meaning in the disclosure or in the claims), the terms “axial” and “axially” generally mean along or parallel to a given axis (e.g., central axis of a body or a port), while the terms “radial” and “radially” generally mean perpendicular to the axis. For instance, an axial distance refers to a distance measured along or parallel to the axis, and a radial distance means a distance measured perpendicular to the axis. Any reference herein to an orientation such as “up,” “upper,” “lower,” “vertical,” “down,” “downward,” “horizontal” and similar terms will be made for the purpose of clarification. Similarly, any reference herein to the terms “inlet” and “exit” will be made for the purpose of clarification. In various embodiments of the technology disclosed herein, the orientation of a piece of equipment or of a component or the flow direction of a fluid may be altered to suit the requirements of differing applications.

This disclosure relates generally to piping connections as applied to fixed structures, such as buildings or chemical processing facilities. More particularly, the disclosure relates to equipment and methods for coupling to a fluid supply line, i.e. a pipe, disposed external to a structure in order to provide a usable connection within the structure. Still more particularly, in at least one embodiment, the disclosure relates to a upwardly terminating building riser for connecting a horizontal supply pipe, which may be sub-terrestrial and may be formed from type C900 polyvinylchloride (PVC). The building riser may be connected to other plumbing within the building, such as, for example, a fire suppression system, a chemical process line, a water distribution system, or sewage piping. As will be explained, the building riser disclosed herein offers a method for easily connecting directly to an expanded coupler, i.e. a “bell,” located at the end of a supply pipe and provides a method for transitioning from PVC pipe to metal pipe.

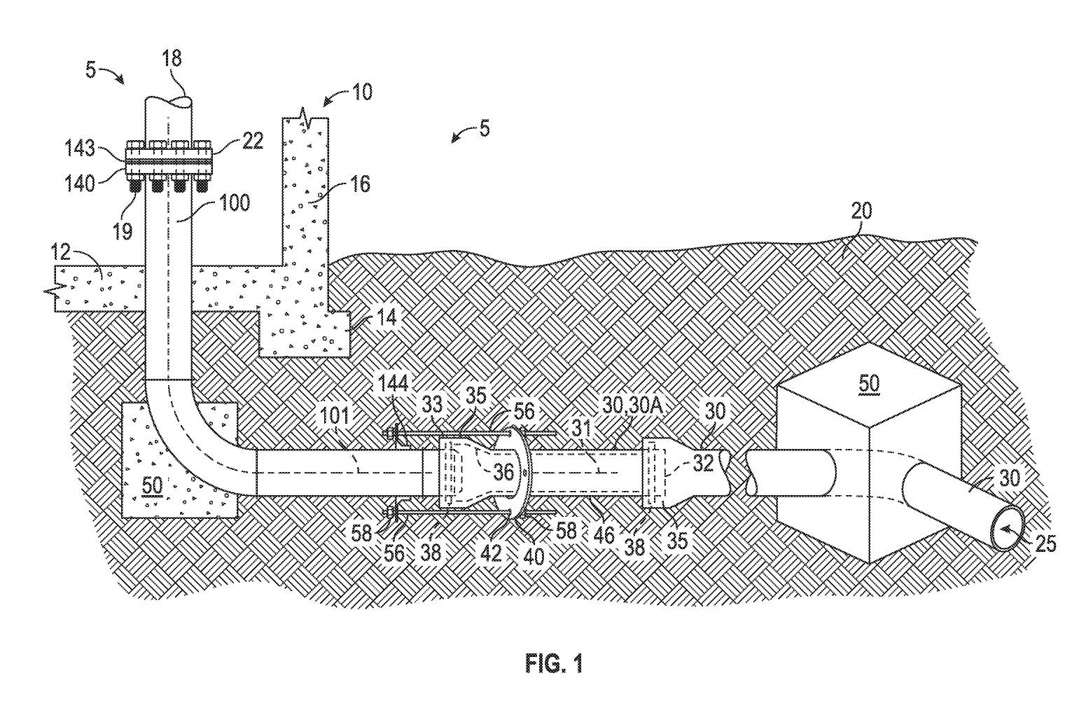

Representing one embodiment, FIG. 1 presents a building system or, more simply, building 10 comprising a poured concrete foundation 12, a foundation footer 14, one or more walls 16, service pipe 18, and a piping member that will be called a tubular coupling member 100, and more specific to this embodiment, will also be called a building riser 100. Building 10 is disposed on, in, or adjacent to the earth 20 in a building zone 5. Building zone 5 represents the region adjacent of earth 20 where building 10 is intended to be built or placed or where building 10 is already built or placed. As installed, building riser 100 extends vertically above and below foundation 12 and extends into earth 20. In various instances of construction, building riser 100 is positioned in building zone 5 prior to the installation or fabrication of foundation 12, footer 14, and walls 16. Building riser 100 includes a bend, and, as installed, the lower portion of riser 100 extends horizontally beyond foundation 12 and footer 14. The vertical portion of riser 100 couples with service pipe 18 associated with building 10. The horizontal portion of riser 100 comprises a straight connector 170 at one end. By means of straight connector 170, riser 100 couples with subterranean fluid supply system 25, mating directly within expanded coupler 35 at one end of a fluid delivery pipe 30 buried within earth 20. Expanded coupler 35 will also be called a bell coupler or, more simply, a bell. In other embodiments, the upper end of riser 100 couples to a blind flange or another sealing member without connecting to a pipe 18. Various embodiments include valves (not shown) coupled to fluid supply system 25, riser 100, or service pipe 18 to control the flow of fluid during installation, maintenance, and operation.

Fluid supply system 25 comprises a plurality of tubular fluid delivery pipes 30, which in FIG. 1 are type C900 PVC water supply pipes. However, other embodiments of system 25 may use another material, such as galvanized steel, ductile iron, or another plastic, for example. FIG. 1 shows only a portion of the at least one branch of system 25. System 25 may comprise other branches reaching other buildings or other locations in building 10. A fluid delivery pipe 30 includes a longitudinal axis 31, a first or inlet end 32 having a substantially uniform outside diameter, a second or exit end 33, and an outer surface 46. Exit end 33 includes the expanded coupler 35. The inner diameter of at least a portion of expanded coupler 35 is greater than the outer diameter of the inlet end 32. The outer diameter of at least a portion of expanded coupler 35 is still greater, giving it a generalized “bell” shape and thus the name. An annular sealing member or seal 38 is disposed circumferentially around inner surface 36 of expanded coupler 35. When two adjacent pipes 30 are axially aligned and coupled, the expanded coupler 35 and seal 38 disposed at exit end 33 of a first pipe 30 slidingly receive and engage a second pipe 30 along outer surface 46 at the inlet end 32. Thereby, two coupled distribution pipes are sealed against fluid loss. It will be recognized in FIG. 1 that hidden lines showing pipe inner surfaces are shown only in relationship to the terminating fluid delivery pipe 30A at the distal end of fluid supply system 25. External pipe surfaces alone are shown elsewhere in FIG. 1.

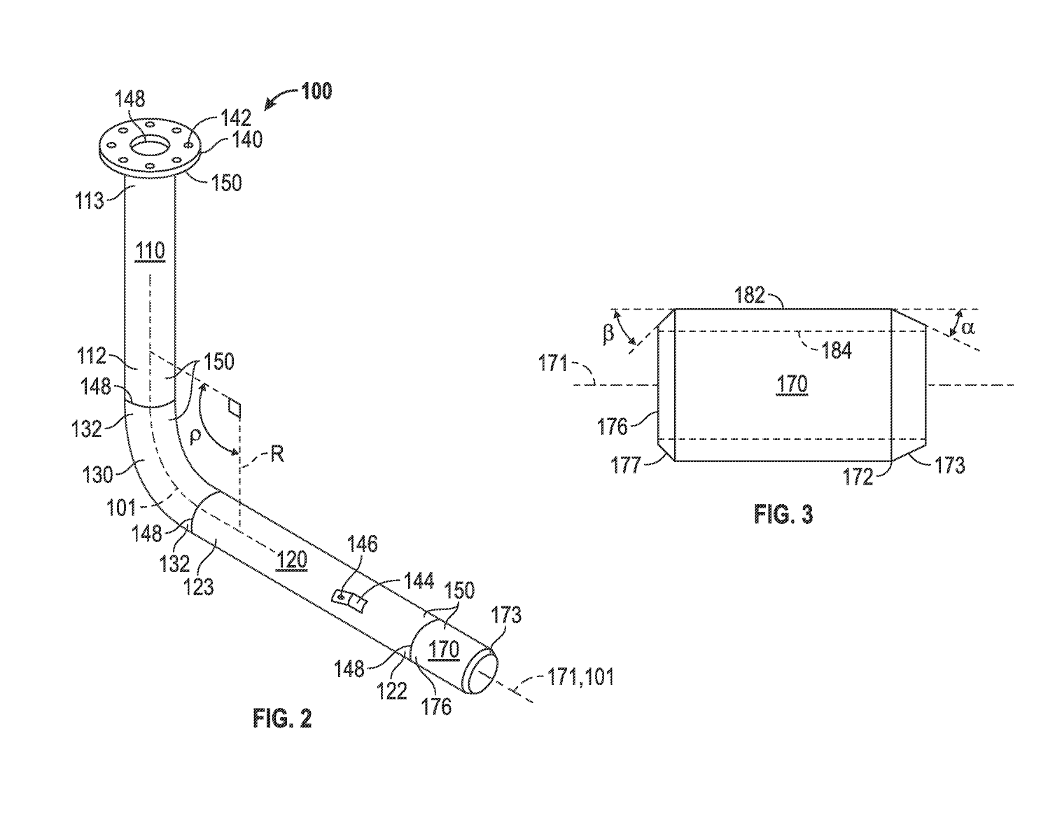

Referring to FIG. 2, building riser 100 is a tubular member that includes an upper pipe 110, a lower pipe 120, an intermediate coupler 130 between the pipes 110, 120, an upper end connector 140, and a tubular-shaped straight connector 170. These members 110, 120, 130, 140, 170 of riser 100 are concentrically aligned along a longitudinal axis 101 and are coupled and sealed by means of junctions 148 between adjacent members. In the embodiment of FIG. 2, junctions 148 are circumferential welds, and end connector 140 is a flange having multiple axially-aligned, circumferentially-spaced through-bores 142. Riser 100 further comprises two or more brackets 144 coupled to lower pipe 120. The portion of bracket 144 extending radially beyond pipe 120 includes an aperture 146. A corrosion resistant coating 150 covers the exposed surfaces of riser 100.

In the assembled building riser 100, upper pipe 110 is a generally vertical portion, lower pipe 120 is a generally horizontal portion, intermediate coupler 130 is an intermediate portion between the generally vertical portion and the generally horizontal portion, tubular-shaped straight connector 170 is straight connector portion at one end of the generally horizontal portion, and upper end connector 140 is coupled to the generally vertical portion distal the intermediate portion.

Best shown in FIG. 3, tubular straight connector 170 comprises a longitudinal axis 171, a first or inlet end 172, a second or exit end 176, an outer surface 182 having a substantially uniform outside diameter between ends 172, 176, and an inner surface 184. Inlet end 172 includes a portion of outer surface 182 and an inlet bevel 173 extending from outer surface 182. Inlet bevel 173 generally follows an acute angle alpha, α, measured from outer surface 182 and parallel to axis 171. The magnitude of angle alpha is chosen so as to reduce the axial force required to engage outer surface 182 with annular seal 38 of expanded coupler 35. More generally, alpha is chosen to improve the coupling between building riser 100 and the expanded coupler 35 of a fluid delivery pipe 30. In FIG. 3, the magnitude of angle alpha is approximately 22 degrees (°), but alpha may be precisely 22° or may be more or less than 22° in other embodiments. As configured, inlet bevel 173 may be called a “long bevel.” Second or exit end 176 includes a weld bevel 177 extending towards and intersecting outer surface 182. Weld bevel 177 generally follows an acute angle beta, β, measured from outer surface 182 and parallel to axis 171. As shown, the magnitude of angle beta is approximately 45°, but beta may be precisely 45° or may be more or less than 45° in other embodiments.

Returning to building riser 100 illustrated in FIG. 2, exit end 176 of straight connector 170 couples to inlet end 122 of lower pipe 120, which couples at its second or exit end 123 to an end 132 of intermediate coupler 130. In this embodiment, intermediate coupler 130 is an elbow fitting. The body of intermediate coupler 130 is defined, in part, by a radius, R, and spans an angle rho, ρ. In FIGS. 1 and 2, angle rho is 90 degrees and intermediate coupler 130 is a “long radius elbow,” as defined in the industry. In other embodiments, rho may be more or less than 90 degrees, for example 45 degrees, and radius R may be more or less than required for a long radius elbow. For example, in some embodiments, connector 130 is a “short radius elbow,” as defined in the industry. The other end 132 of coupler 130 joins to first or inlet end 112 of upper pipe 110, which couples at its second or exit end 113 to end connector 140.

Like end 176 of straight connector 170 in FIG. 3, the ends of upper pipe 110, lower pipe 120, intermediate coupler 130, and end connector 140 comprise weld bevels (not shown) to facilitate and improve the strength and quality of the circumferential welds that form the junctions 148 in this embodiment. In FIG. 2, the welds of junctions 148 are butt welds. A junction 148, when formed as a weld, may start as one or more circumferentially spaced tack welds to insure alignment of adjacent members. A junction 148 may be fabricated by forming a circumferential root pass weld (not shown) extending into the inner surface of the tubular members, such as inner surface 184 of straight connector 170 and the inner surface of lower pipe 120. The junction 148 may be completed by one or more additional, circumferential welding passes disposed radially beyond the root pass. Other welding and coupling techniques may be employed to join the members 110, 120, 130, 140, and 170, such as socket welding, which does not require bevels at the end of each member, and such as a compression or interference fit.

In FIG. 2, the members 110, 120, 130, 140, and 170 of riser 100 comprise carbon steel, and corrosion resistant coating 150 is a hot-dipped galvanizing coating, applied after the members 110, 120, 130, 140, and 170 and brackets 144 of building riser 100 are coupled, e.g. welded together. Various dimensions, including the outside diameter, the inside diameter, and thus the wall thickness of upper pipe 110, lower pipe 120, intermediate couple 130, and straight connector 170 are sized according to schedule 10 pipe, as defined in the industry. The dimensions of end connector 140, i.e. the flange, are sized for a pressure rating of 150 pounds-per-square-inch. During intermediate states of fabrication, the aforesaid dimensions of members 110, 120, 130, 140, and 170 may be specified, adjusted, or reduced so that riser 100 achieves the targeted dimensions for schedule 10 pipe with a 150 pound flange after coating 150 has been applied, and fabrication is complete. In other embodiments of building riser 100, other materials and other pipe schedules (for example, schedule 40) or pressure ratings may be used for members 110, 120, 130, 140, and 170. Other materials include stainless steel, brass, C900 PVC, copper, or any other suitable material known in the art. Some of these other materials may include a corrosion resistance coating or may not require the addition of coating 150. Some of the other materials for other embodiments of riser 100, such as C900 PVC, may require that extra structure be added support building service pipe 18 of FIG. 1. In some embodiments, the welds that form junctions 148 are replaced by threaded, brazed, soldered, or cemented connections, for example, and various ends of upper pipe 110, lower pipe 120, intermediate coupler 130, end connector 140 comprise, and end 176 of straight connector 170 are formed with a shape other than a weld bevel.

Again referring to building 10 in FIG. 1, end connector 140 of building riser 100 matingly couples and seals to another end connector 22, e.g. a flange, of corresponding size and compatible shape on building service pipe 18. In this embodiment, end connector 22 is a flange like end connector 140. In various embodiments, a sealing member 143, for example a gasket, between the two end connectors seals against radial fluid flow, i.e. fluid loss or fluid gain. Multiple pairs of threaded bolts and nuts or other suitable fasteners 19 hold the two exemplarily flanges together, i.e. end connectors 140, 22. Building service pipe 18 comprises carbon steel; although, in other embodiments pipe 18 may be another suitable material, including, for example, copper, brass, or a plastic such as PVC. Beneath foundation 12, a thrust block 50 surrounds a portion of riser 100 with the intent to fix or hold it in position against possible fluid forces, weights, or the shifting of portions of earth 20. As introduced earlier, adjacent building 10, the expanded coupler 35 and annular seal 38 of a fluid delivery pipe 30 slidingly receive inlet end 172 of straight connector 170 at the lower, horizontal end of riser 100. In particular, straight connector 170 couples with the terminating fluid delivery pipe 30A at the distal end of fluid supply system 25.

Along the run of fluid supply system 25, a fluid delivery pipe 30, which may be straight or curved, is partially surrounded by a second thrust block 50 at least in this embodiment. The two thrust blocks 50 are configured to hold or to reduce the movement of riser 100 and one or more fluid delivery pipes 30 against possible fluid forces, weights, or the shifting of portions of earth 20. The thrust blocks 50 are configured to stabilize the coupling of riser 100 and fluid supply system 25 and to maintain a leak-tight connection therebetween. In FIG. 1, the two thrust blocks 50 are formed from poured concrete; although, prefabricated concrete or another suitable material may be used.

In addition to the concrete thrust blocks 50, a bracket, which in this example is an annular bracket 40, is coupled to outer surface 46 of the terminating pipe 30A, which mates riser 100. Annular bracket 40 includes multiple, circumferentially spaces apertures 42. Two or more compression-inducing members, such tie-rods 56, extend through apertures 42 in bracket 40 and apertures 146 in brackets 144 on riser 100. Tie-rods 56 may comprise all-thread, i.e. a fully threaded metal rod. Beyond brackets 40, 144, each tie-rod 56 is held by fasteners 58, such as threaded nuts, crimped fittings, coupled pins, bent ends on tie-rod 56, or any other suitable fastener. When a tension force is developed in tie-rods 56, and the tension is held by fasteners 58, the tie-rods 56 induce compression in riser 100 and the mating pipe 30A, maintaining a leak-tight connection therebetween. Brackets 40, 144, tie-rods 56, and fasteners 58 are configured with sufficient strength so they may be used to develop tension and axially engage the end of riser 100 with expanded coupler 35 and seal 28 on pipe 30. This engagement occurs prior to the completion of one or both of the thrust blocks 50. In other embodiments, no bracket 40 or compression member (e.g. tie-rod 56) is coupled to an outer surface 46 of pipe 30A and riser 100; instead, only the multiple thrust blocks 50 are used to maintain the relative positions of building riser 100 and one or more pipes 30, 30A of fluid supply system 25. In still other embodiments, brackets 40, 144 and tie-rods 56 couple and fix building riser 100 to fluid supply system 25 without the aid of thrust blocks 50.

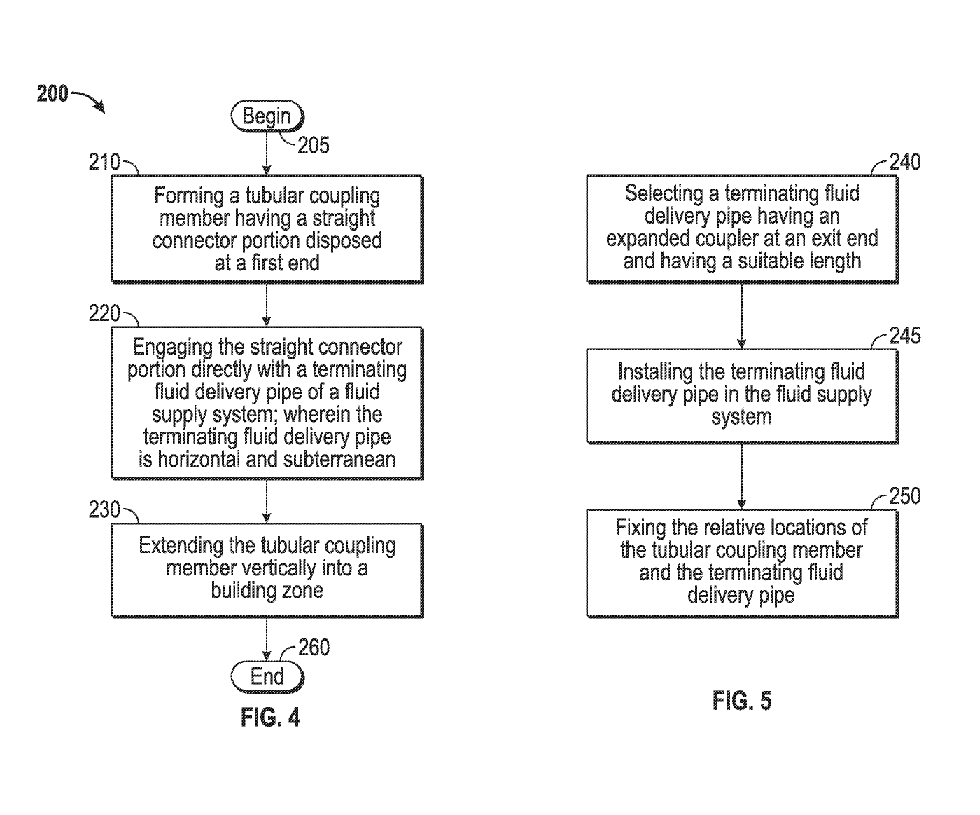

Referring to FIG. 4, method 200 is an embodiment of a method transitioning a subterranean fluid supply system into a building zone. Method 200 begins at step 205 and ends at step 260. Operation step 210 involves forming a tubular coupling member having a straight connector portion disposed at a first end. In at least one embodiment, the method also adds an inlet bevel or a rounded end to the straight connector. Step 220 comprises engaging the straight connector portion directly with a terminating fluid delivery pipe of the fluid supply system; wherein the terminating fluid delivery pipe is horizontal and subterranean. Step 230 involves extending the tubular coupling member vertically into a building zone.

In some instances, additional steps from FIG. 5 are incorporated into method 200. These steps include step 240 involving selecting a terminating fluid delivery pipe having an expanded coupler at an exit end and having a suitable length to extend between the remainder of the fluid supply system, which may be like fluid supply system 25, and the tubular coupling member. Step involves installing the terminating fluid delivery pipe in the fluid supply system. Step 250 involves fixing the relative locations of the tubular coupling member and the terminating fluid delivery pipe, which may be accomplished, for example, using tie-rods 56, extend through apertures 42 in bracket 40 and apertures 146 in brackets 144 as shown in FIG. 1.

The method 200 allows for flexibility. For example, the sequence of two or more operation steps of method 400 might be rearranged in some embodiments. Other embodiments of method 400 include additional operations or may exclude one or more of the operational steps listed.

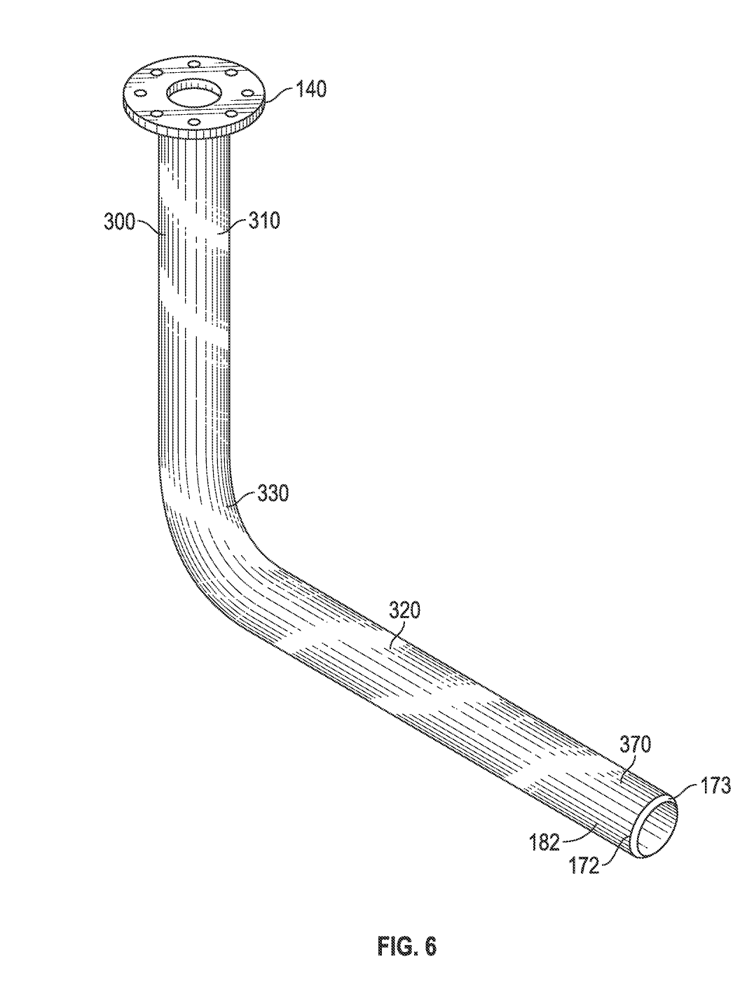

Referring now to FIG. 6, a tubular coupling member 300 compatible with various water supply applications, including the building system 10 and fluid supply system 25 of FIG. 1, for example. Tubular coupling member 300 includes a generally vertical portion 310, a generally horizontal portion 320, an intermediate portion 330 between the vertical portion 310 and the horizontal portion 320, a straight connector portion 370 at one end of the horizontal portion 320. In this embodiment, tubular coupling member 300 is formed from a single, contiguous piece of bent pipe or tubing with the addition of an upper end connector 140 coupled to the vertical portion 310 distal the intermediate portion 330. Straight connector portion 370 comprises an inlet end 172 and an outer surface 182 having a substantially uniform outside diameter. Inlet end 172 includes a portion of outer surface 182 and an inlet bevel 173 extending from outer surface 182. Inlet bevel 173 generally follows an acute angle alpha, α, as previously described.

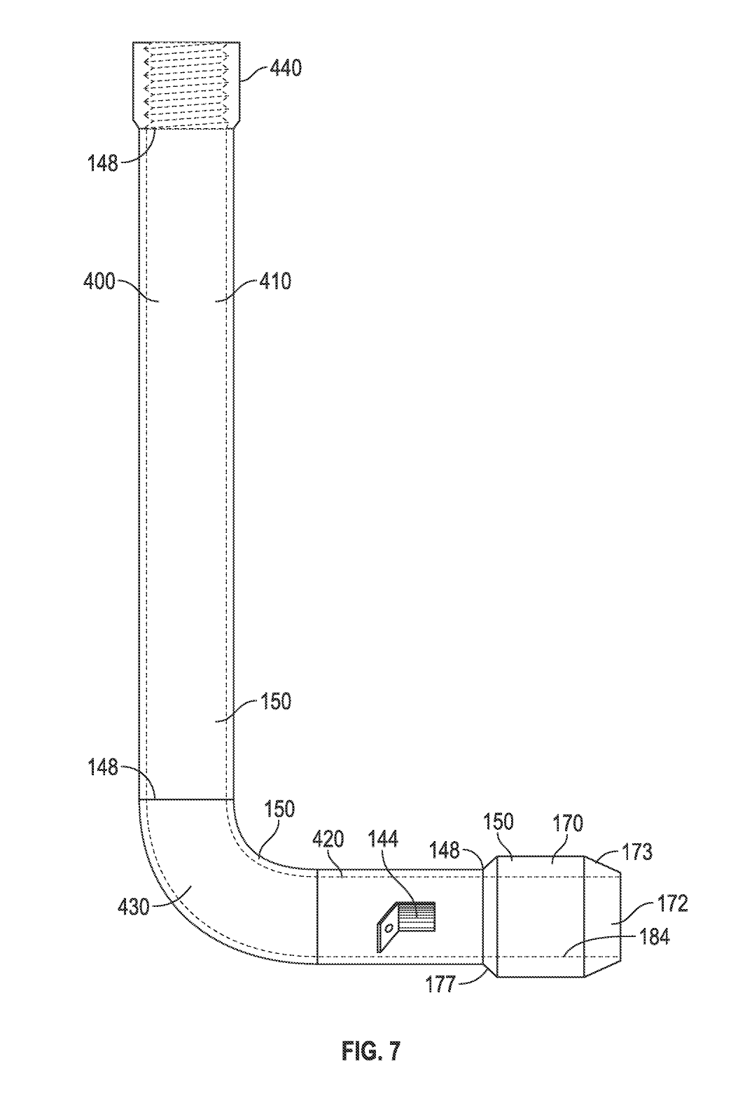

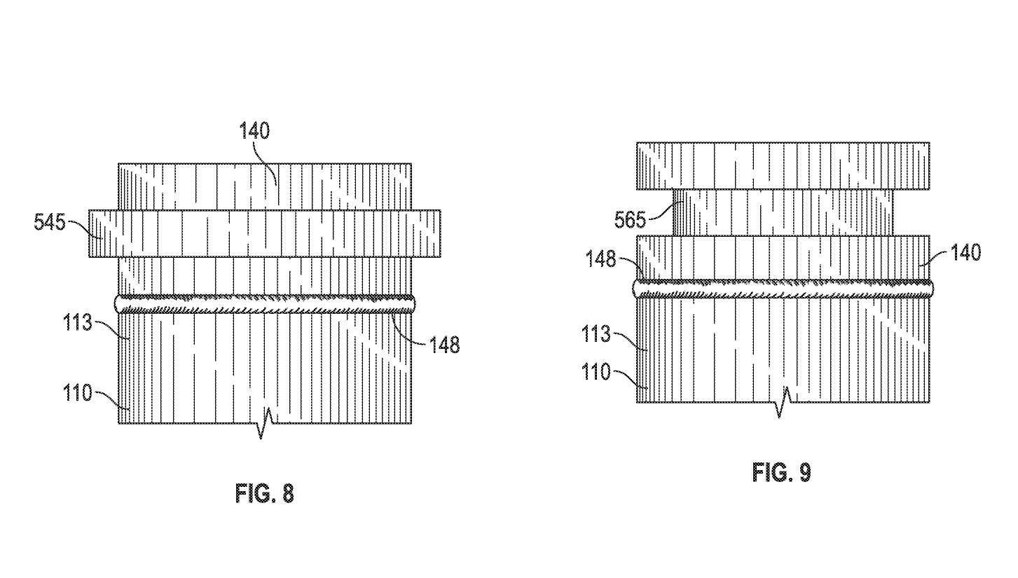

FIG. 7 shows a tubular coupling member 400 compatible with various water supply applications, including the building system 10 and fluid supply system 25 of FIG. 1, for example. Tubular coupling member 400 is particularly suited as s fire department connection quick coupler. In various applications, tubular coupling member 400 couples to a fire department connection (not shown) outside or independent of a building. Tubular coupling member 400 includes an upper pipe 410, a lower pipe 420, an intermediate coupler 430 between the pipes 410, 420, an upper end connector 440, and a tubular-shaped straight connector 170. These members 410, 420, 430, 440, 170 of riser 100 are aligned along a longitudinal axis (not shown) and are coupled and sealed by means of junctions 148 between adjacent members. In the embodiment of FIG. 7, junctions 148 are a circumferential welds, and end connector 140 is a internally threaded pipe coupling. In various other embodiments, at least one of the junctions 148 are formed as a threaded connection between a pair of adjacent, threaded members. Riser 100 further comprises two or more brackets 144 coupled to lower pipe 420. The portion of bracket 144 extending radially beyond pipe 120 includes an aperture 146. A corrosion resistant coating 150 covers the exposed surfaces of riser 400. At least in the embodiment of FIG. 7, upper pipe 410 is longer that lower pipe 420.

In the assembled building riser 400, upper pipe 410 is a generally vertical portion, lower pipe 420 is a generally horizontal portion; intermediate coupler 430 is an intermediate portion between the generally vertical portion and the generally horizontal portion; tubular-shaped straight connector 470 is straight connector portion at one end of the generally horizontal portion; and upper end connector 140 is coupled to the generally vertical portion distal the intermediate portion.

Thus whether by Method 400 or by application of any of the tubular coupling members 100, 300, 400 disclosed herein or formed based on the teachings herein, the connection between a fluid supply system and the tubular coupling member is direct without a separate piece of pipe in between. This direct connection between fluid supply system and the tubular coupling member offers economic and scheduling benefits in various instances.

### Additional Information

Although building 10 was shown with a poured concrete foundation and walls, in other embodiments, building riser 100 is installed in a structure having other forms of construction such as a building with a poured foundation and a wood-framed wall, a building having floor joists and flooring panels suspended over a crawl space, a building elevated on poles which may require additional piping to extend vertically between building riser 100 and the foundation or the floor of the building. Building riser 100 may also be installed in a facility with a foundation but no enclosing walls or few enclosing walls, such as are the designs of some chemical processing and manufacturing facilities. In some cases dirt, gravel, or another surface may replace the foundation. In addition, in some embodiments, the entirety of building riser 100 and at least the mating portion of fluid supply system 25 are disposed above the surface of earth 20, being supported by one or more thrust blocks 50 or by other suitable support structure.

Although, pipes and fittings have been shown as cylindrical, possessing a round cross-section, in other embodiments, one or more of these tubular members or portions of one or more of these tubular members may have a cross-section of another shape, such as rectangular, elliptical, triangular, or oval.

In the example of in FIG. 3, outer surface 182 of straight connector 170 comprises a “generally constant outside diameter.” The following example will give a broader understanding of this phrase, as used in the description and in the claims. In some embodiments, a portion of outer surface 182 is modified to comprise an increasing and/or a decreasing taper as it extends between inlet end 172 and exit end 176. So long as the taper does not interfere with the ability of the modified outer surface 183 to fit within expanded coupler 35 and to seal against annular seal 38, the modified outer surface 183 falls within the definition of a surface having a generally constant outside diameter.

In some embodiments of straight connector 170, an edge of first end 172 may be rounded or filleted instead of comprising an inlet bevel 173. In some other embodiments, the beveling, rounding, or filleting of the inlet end may be intersect both the outer surface and the inner surface of the straight connector. For example, in addition to the bevel 173 that intersects outer surface 182 as shown in FIG. 3, another bevel, possibly with an angle different than alpha, may intersect inner surface 184 at inlet end 172. This second bevel may be added for the purpose of reducing friction between inner surface 184 and a moving fluid.

For building riser 100 of FIG. 1 and FIG. 2, end connector 140 has been described as a flange. However, in other embodiments, building riser 100 may be coupled to a building service pipe 18 by any suitable means of coupling known in the art. For example riser 100 may be welded to pipe 18. As another example, a groove or a lip (not shown) in upper pipe 110 adjacent exit end 113 may be installed in place of a flange as the upper end connector 140 and may be engaged by a generally circumferential clamp, the clamp providing an axial force and/or a radial force to couple riser 100 to a pipe 18 having a similar groove or lip. In another example, a weld bevel may be formed at second end 113 of upper pipe 110, the bevel being the upper end connector for the building riser with coupling to pipe 18 accomplished by a butt weld in place of fasteners 19.

Although intermediate coupler 130 was disclosed for at least one embodiment as being an elbow fitting, in various other embodiments, intermediate portion 130, 330, 430, may comprise another fitting that advantageously transitions the riser 100 from the orientation of fluid supply system 25, which is horizontal or is sloped from horizontal in various applications, to the orientation of service pipe 18, which is vertical or extends in a direction other than vertical in various applications. For example, in various embodiments the intermediate portion is formed from a plurality of pieces of pipe butt-welded together at various angles. In some other embodiments, the intermediate portion include multiple elbows.

While exemplary embodiments have been shown and described, modifications thereof can be made by one skilled in the art without departing from the scope or teachings herein. The embodiments described herein are exemplary only and are not limiting. Many variations and modifications of the systems, apparatus, and processes described herein are possible and are within the scope of the invention. For example, the relative dimensions of various parts, the materials from which the various parts are made, and other parameters can be varied. Examples of other, broader variations have been explained. Accordingly, the scope of protection is not limited to the embodiments described herein, but is only limited by the claims that follow, the scope of which shall include all equivalents of the subject matter of the claims.

What is claimed is:

1. A tubular coupling member configured to couple a subterranean fluid delivery pipe disposed external to a building with a service pipe disposed inside the building, the tubular coupling member comprising:
a first pipe having two ends;
a second pipe having a first end and a second end;
an intermediate coupler coupled to and disposed between an end of the first pipe and the second end of the second pipe; and
a tubular straight connector having a substantially uniform outside diameter and having a leading end and a terminating end; wherein the terminating end directly engages the first end of the second pipe.

2. The tubular coupling member of claim 1 further comprising:
An end connector coupled to the first pipe and disposed at the end opposite the intermediate coupler.

3. The tubular coupling member of claim 1 wherein the leading end of the straight connector includes a long bevel adapted for installing the straight connector directly within a bell coupler on a fluid delivery pipe.

4. A tubular coupling member configured to couple an expanded coupler of a fluid delivery pipe disposed external to a building with a service pipe disposed inside the building, the tubular coupling member comprising:
a generally vertical portion;
a generally horizontal portion having a straight connector portion at one end;
an intermediate portion between the generally vertical portion and the generally horizontal portion and distal the straight connector portion; and
An end connector coupled to the generally vertical portion distal the intermediate portion;
Wherein the straight connector portion having an outer surface of substantially uniform diameter and a leading end configured to engage directly within the expanded coupler of the fluid delivery pipe.

5. The tubular coupling member of claim 4 wherein outer surface of the straight connector portion comprises a substantially uniform diameter and the leading end includes a long bevel.

6. The tubular coupling member of claim 4 wherein the straight connector portion comprises an outer surface; and
wherein the long bevel is generally 22 degrees from the outer surface of the straight connector portion.

7. A method for transitioning a subterranean fluid supply system into building zone, the method comprising:
forming a tubular coupling member having a straight connector portion disposed at a first end;
engaging the straight connector portion directly with a terminating fluid delivery pipe of the fluid supply system; wherein the terminating fluid delivery pipe is horizontal and subterranean; and
extending the tubular coupling member vertically into a building zone;

8. The method of claim 7 wherein the straight connector portion comprises substantially uniform outside diameter.

9. The method of claim 7 further comprising:
selecting a terminating fluid delivery pipe having an expanded coupler at an exit end and having a suitable length;
installing the terminating fluid delivery pipe in the fluid supply system;

10. The method of claim 7 further comprising:
fixing the relative locations of the tubular coupling member and the terminating fluid delivery pipe.
